(19) United States
(12) Patent Application Publication
(10) Pub. No.: US 2012/0318155 A1
(43) Pub. Date: Dec. 20, 2012

(54) Cleaning apparatus for cleaning priniting machine rotary cylinders

(76) Inventors: Christian Fappiano, Torre de' Busi (LC) (IT); Luigi Fappiano, Torre de' Busi (LC) (IT)

(21) Appl. No.: 13/373,908

(22) Filed: Dec. 5, 2011

(30) Foreign Application Priority Data
Jun. 20, 2011 (IT) MI2011A001110

(51) Int. Cl. B41F 35/02

(52) U.S. Cl. 101/425

(57) ABSTRACT

A cleaning apparatus for cleaning printing machines rotary cylinders, characterized in that said cleaning apparatus comprises a delivery device providing a cleaning material to nozzle means for spraying said cleaning material on a cylinder to be cleaned, said cleaning apparatus further comprising suction means for sucking the used cleaning material and guide means allowing to displace said nozzle and suction means along a cylinder directrix line to perform a cleaning operation through the overall extension of said cylinder.

### BACKGROUND OF THE INVENTION

The present invention relates to a cleaning apparatus for cleaning printing machine rotary cylinders.

As it is known, a printing machine, for example an offset printing machine, comprises a plurality of printing units each of which includes one or more printing cylinders.

More specifically, a printing rotary machine conventionally comprises four or more printing turrets each of which includes two printing cylinders, coated by a rubber material, which perform a printing operation on the two faces of a paper strip.

Said prior printing rotary machine, accordingly, comprises at least eight rubber coated cylinders, each of which must be periodically cleaned, usually after a half hour working period.

At present, said printing cylinders are cleaned or washed by automatically operated washing bars being applied to each of the printing cylinder to be cleaned.

A prior washing system for washing a rubber material coated printing cylinders provides to use specifically designed oil based solvent materials, allowing to remove printing ink adhering to the printing cylinders, during the cylinder rotary movement.

Such a prior cleaning or washing system provides moreover to use specifically designed cleaning cloth or fabric materials to remove adhering waste printing ink from the rotary cylinders.

The used solvents and other chemical products generate chemical polluting waste material which must be disposed of according to very stringent disposal of regulations.

A typical offset printing rotary machine operates with a printing rate up to 45,000 copies/hour and the cleaning or washing of the cylinders, requiring about 20 seconds, must be performed each 30 printing minutes, in most favorable conditions and, at a maximum, each 60 minute period.

In this connection, it should be apparent that printed copies made during the cleaning or washing operation must be also disposed of, and considering for example a typical operating cycle therein 12 printed sheets are made for second, the number of the disposed of sheets or copies in a washing or cleaning period of 20 seconds, is of about 250.

To the above waste copies due to the washing or cleaning operation it is moreover necessary to add about further 450 copies disposed of because of quality reasons, for a total of about 700 waste copies in a cleaning or washing operation time period.

With 24 cleaning or washing operations performed each day, we will have, in a 24 hour period, about 16,800 waste copies.

If 48 washing operations per day are carried out, then the disposed of copies will be about 33,600.

To the cost of the disposed of copies it is necessary to further add that related to cylinder cleaning oil based solvent materials and fabric pieces, and that cost necessary for disposing of the waste caused by the printing cylinder washing system must be added.

Such a total cost depend on the paper material weight and coil height, solvent substances, and is always a very high one.

### SUMMARY OF THE INVENTION

Accordingly, the aim of the present invention is to provide such a cleaning apparatus for cleaning printing machine rotary cylinders, in particular offset printing machine cylinders, adapted to overcome the above mentioned prior art drawbacks.

Within the scope of the above mentioned aim, a main object of the invention is to provide such a cleaning apparatus adapted to perform a perfect cleaning operation without interrupting the printing machine operating cycle and generating waste materials.

Yet another object of the present invention is to provide such a cleaning apparatus adapted to use non polluting washing or cleaning materials and products.

Yet another object of the present invention is to provide such a cleaning apparatus adapted to greatly reduce the printing cylinder washing cost and which may be made starting from easily available elements and materials.

Yet another object of the present invention is to provide such a cleaning apparatus which, owing to its specifically designed features, is very reliable and safe in operation.

The above mentioned aim and objects, as well as yet other objects, which will become more apparent hereinafter, are achieved by a cleaning apparatus for cleaning printing machine rotary cylinders, characterized in that said cleaning apparatus comprises a delivery device providing a cleaning material to nozzle means for spraying said cleaning material on a cylinder to be cleaned, said cleaning apparatus further comprising suction means for sucking the used cleaning material and guide means allowing to displace said nozzle and suction means along a cylinder directrix line to perform a cleaning operation through an overall extension of said cylinder.

The cryogenic material generated by the delivery device is supplied to the nozzle means which carry out a cryogenic sandblasting operation.

The material removed by said sandblasting operation is sucked by the suction means.

### BRIEF DESCRIPTION OF THE DRAWINGS

Further characteristics and advantages of the present invention will become more apparent from the following disclosure of a preferred, though not exclusive, embodiment of the invention, which is illustrated, by way of an indicative, but not limitative, example in the accompanying drawings, where:

FIG. 1 is a perspective view of the inventive cleaning apparatus for cleaning rotary cylinder being applied to an offset printing machine;

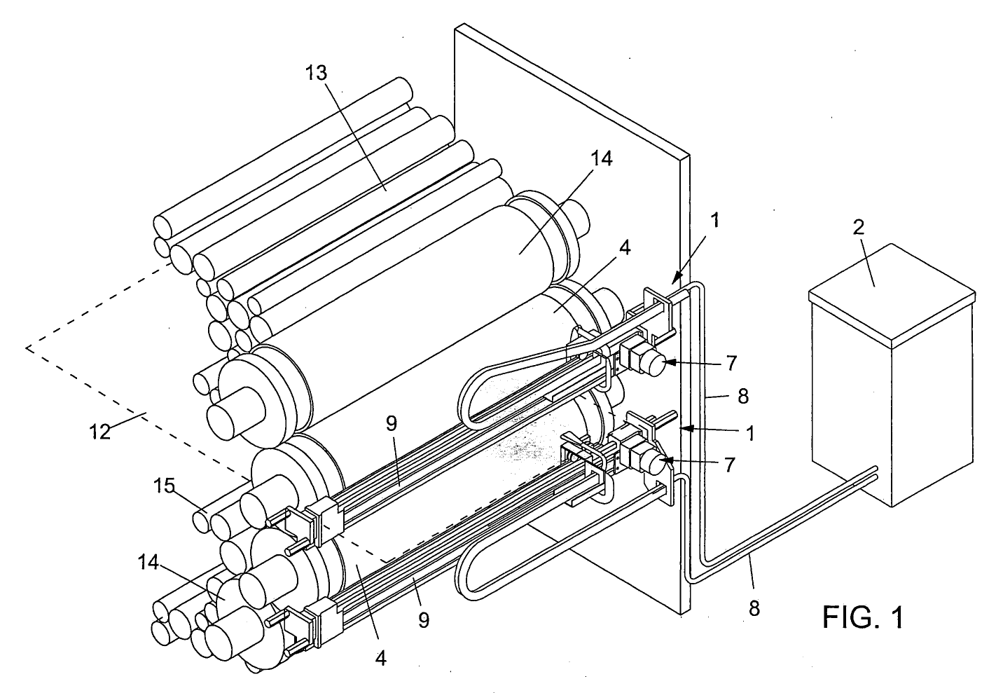

FIG. 2 is a side elevation view, as partially cross-sectioned, of a cleaning unit included in the cleaning apparatus according to the present invention;

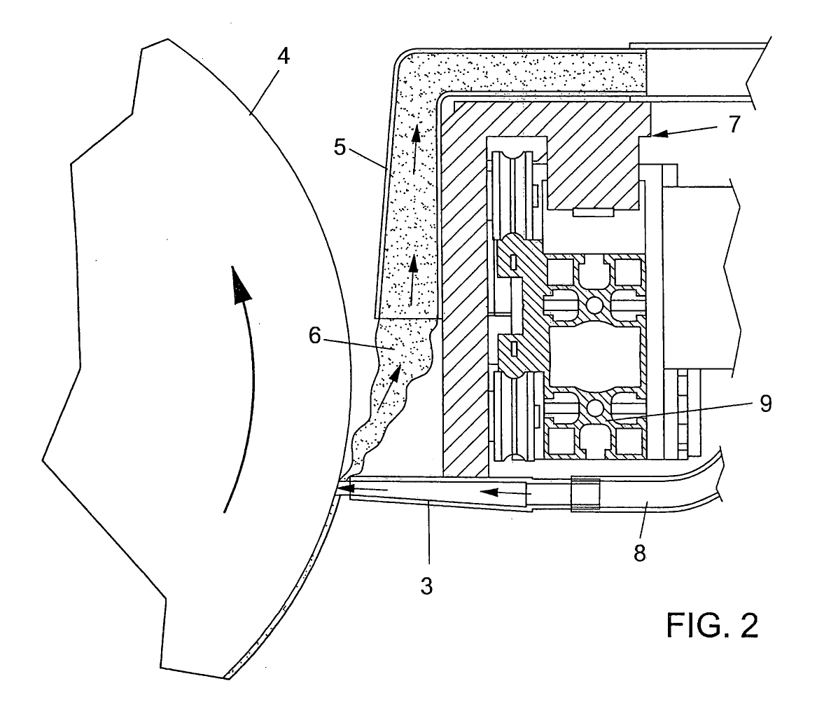

FIG. 3 is a side elevation view showing a pair of cleaning units applied to a pair of rubber coated printing cylinders;

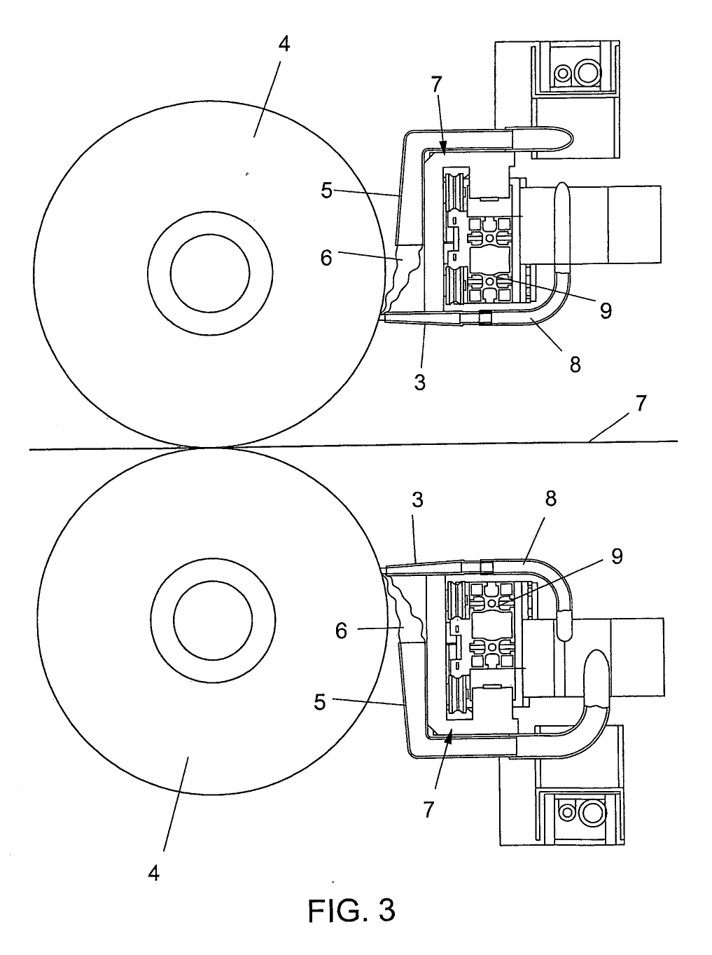

FIG. 4 is a front view of the cleaning apparatus;

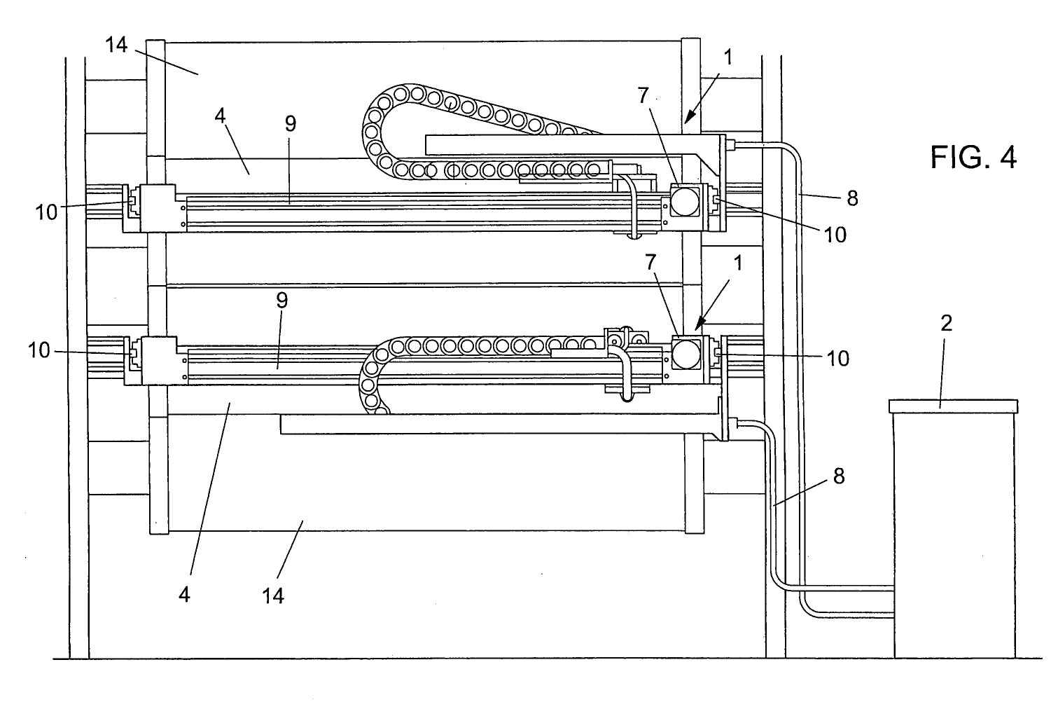

FIG. 5 is a side elevation view of the overall inventive apparatus; and

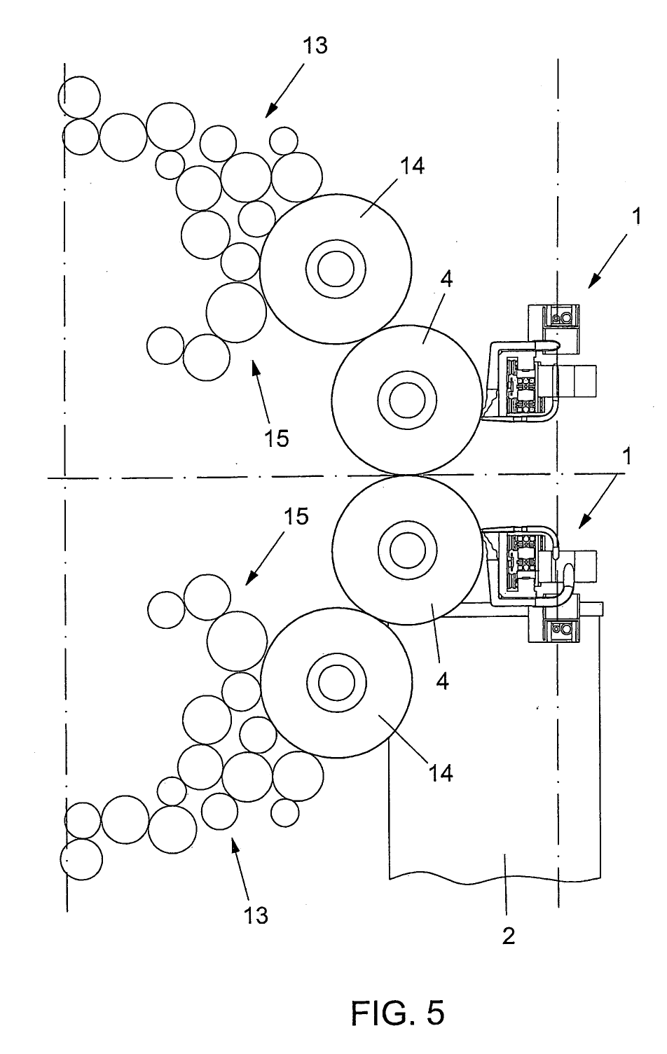

FIG. 6 is yet another perspective view showing a four color printing unit including a cylinder cleaning apparatus according to the present invention.

### DESCRIPTION OF THE PREFERRED EMBODIMENTS

With reference to the number references of the above mentioned figures, the cleaning apparatus for cleaning printing machine rotary cylinder according to the present invention, which has been indicated generally by the reference number 1, comprises a hopper/delivery device 2 supplying a cleaning material to nozzle means 3 for spraying said cleaning material on a printing cylinder 4 to be cleaned.

The inventive apparatus further comprises suction means 5 for sucking the material 6 which has been used for cleaning purposes.

According to the present invention, the apparatus further comprises guide means allowing to displace said nozzle and suction means along a cylinder directrix line to perform a cleaning operation through the overall extension of said cylinder.

Said cleaning material is preferably a cryogenic cleaning material, for example constituted by CO₂ pellets.

More specifically, said hopper or delivery device 2 supplies the nozzle means through supplying or feeding flexible pipes 8 coupled to the nozzle means comprising one or more nozzle elements 3 associated to a carriage 7.

Said carriage 7 also supports the suction means comprising, in this embodiment, a suction mouth 5 coupled to a vacuum circuit for sucking waste materials 6 generated in the washing or cleaning operation.

Said hopper is designed for loading the raw material to carry out the cryogenic cleaning process, said material comprising, for example, CO₂ pellets.

In said hopper or delivery device 2, the cryogenic material, preferably in a pressurized condition is conveyed, through a thermally insulated pipe assembly 8 to the nozzle 3, installed on the carriage 7 which slides on a motorized guide 9 parallel to the axis of the cylinder 4 and mounted on two linear guides 10 adapted to perform cross movement with respect to the motorized guide 9, thereby displacing the washing system toward said cylinder 4 for cleaning it.

Said linear guides 10 being driven through a small movement from a rest position to a washing position thereof, where said nozzle means 3 is moved toward the surface of the cylinder 4 to be cleaned.

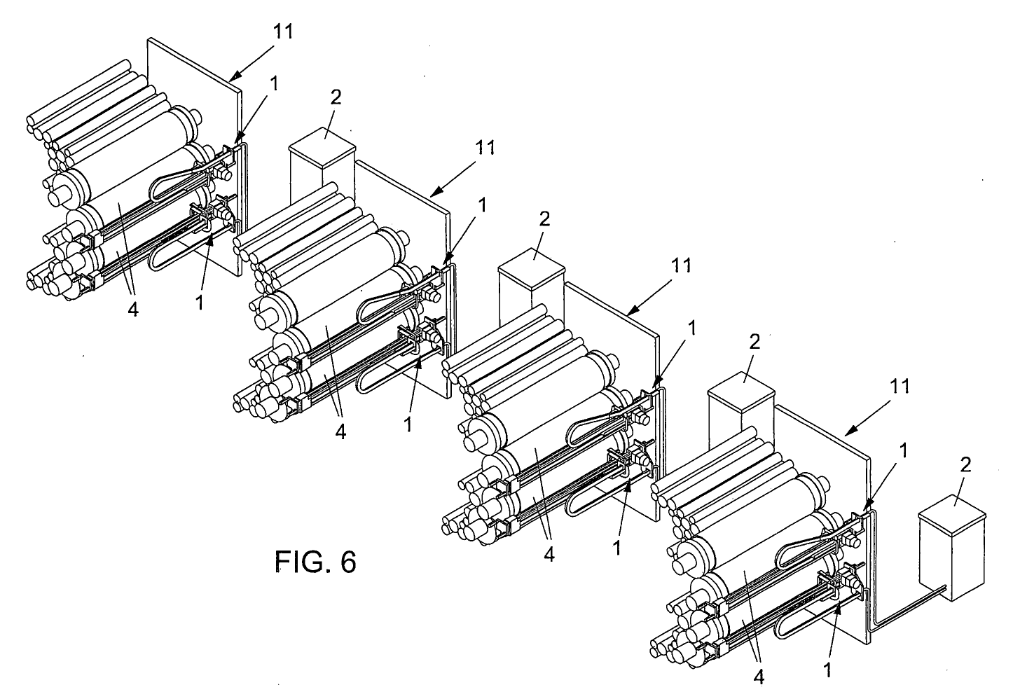

The disclosed embodiment of the present invention is related to a cleaning system for cleaning a rubber coated printed cylinder 4 of an offset printing machine generally comprising a plurality of printing units, indicated by the reference number 11 in FIG. 6.

In such a machine, each printing unit 11 comprises two rubber coated cylinders 4 each arranged on a side of the strip 12 to be printed upon.

Each said rubber coated cylinder 4 is associated with a respective plate cylinder 14 receiving printing ink from inking rollers 13, said plate cylinder 14 being further coupled to inking rollers 13.

Said plate cylinder 14 is also connected to wetting rollers 15.

Each said cleaning unit may be supplied with a cleaning material by a single hopper or delivery device 2, for all the apparatus cleaning units, or by an individual delivery device 2 for each cleaning unit, depending on requirements and the printing machine thereon the cleaning apparatus according to the present invention must be mounted.

A preferred cleaning material, according to the present invention is a gaseous mixture of CO₂ and pressurized air which, by the above disclosed delivery system, is directed on the overall surface of the rotary printing cylinder.

Thus, by a thermal shock effect, the dirt material is transformed to a powder and the suction means remove all the dry ink particles and convey the removed part to a filter.

By using, for example CO₂ at a temperature of

−80° C., the cleaning of the rubber coating of the printing cylinder will be perfectly performed and the ink is transformed into powder.

This operation is performed with the printing machine in operation and no waste printed sheet or copy is generated.

The delivery of the gas, for example solid status CO₂, is performed automatically and may also be carried out by an existing gas delivery system used for other purposes.

The above disclosed apparatus allows to perform a distribution through the overall surface of the cylinder to be cleaned, through the motorized guide parallel to the cylinder axis and being mounted on two linear guides performing a cross movements with respect to the motorized guide to cause the washing system to be moved toward the cylinder to perfectly clean the latter.

The linear guides perform a small movement from their rest position to their washing or cleaning position.

It has been found that the invention fully achieves the intended aim and objects.

In fact, the invention has provided a cleaning apparatus adapted to perfectly clean rubber coated printing cylinders or any other type of cylinders, without generating waste materials and in a fully automatic and reliable manner.

The inventive apparatus may operate with different cleaning materials even if, by way of an example, pressurized CO₂ pellet has been indicated.

The CO₂ temperature may vary from −300° C. to 0° C.

The CO₂ pellet particle size may have any desired value. The number of washing units to be applied to each operating turret of a printing machine may vary from one to several units.

The apparatus according to the present invention allows to fully eliminate cost related to the cylinder washing time, white paper, solvent substances, waste materials to be disposed of, caused by prior washing systems.

The inventive apparatus moreover allows to clean the printing cylinder with the printing machine in operation and up to the end of the printing operation without wasting raw or white paper, solvents and generating special waste substances, thereby greatly reducing the operating cost while meeting environmental safe and health requirements.

In practicing the invention, the used materials, as well as the contingent size and shapes, can be any, according to requirements.

1. A cleaning apparatus for cleaning printing machines rotary cylinders, characterized in that said cleaning apparatus comprises a delivery device providing a cleaning material to nozzle means for spraying said cleaning material on a cylinder to be cleaned, said cleaning apparatus further comprising suction means for sucking used cleaning material and guide means for displacing said nozzle and suction means along a cylinder directrix line to perform a cylinder cleaning operation through the overall extension of said cylinder.

2. An apparatus, according to claim 1, characterized in that said cleaning material is a cryogenic material.

3. An apparatus, according to claim 1, characterized in that said cleaning material is a gaseous mixture of CO₂ and pressurized air ejected on an overall surface of said rotatively driven printing cylinder.

4. An apparatus, according to claim 1, characterized in that said delivery device supplies the nozzle means through flexible supplying hoses coupled to said nozzle means, said nozzle means comprising one or more nozzle elements associated with a carriage, said carriage also supporting said suction means, said suction means comprising a suction mouth coupled to a vacuum circuit for sucking waste materials generated by the washing or cleaning operation.

5. An apparatus, according to claim 1, characterized in that said delivery device comprises a raw material hopper for loading therein a raw cleaning material for performing a cryogenic process in said delivery device, under pressure, and being conveyed, through an insulated pipe, to said nozzle means.

6. An apparatus, according to claim 4, characterized in that said carriage is slidably driven on a motorized guide parallel to an axis of the cylinder to be cleaned and mounted on two linear guides adapted to perform a cross movement with respect to the motorized guide thereby causing the washing system to be moved toward said cylinder for cleaning said cylinder, said linear guides being driven through a small movement from a rest position to a washing position thereof where said nozzle means is moved toward a surface of the cylinder to be cleaned.

7. An apparatus, according to claim 1, characterized in that said apparatus is applied to rubber coated cylinders of an offset printing machine comprising a plurality of printing units, each said printing unit comprising two rubber coated cylinders arranged on each side of a strip to be printed upon, each said rubber coated cylinder being associated with a respective plate cylinder receiving a printing ink from inking rollers, said plate cylinder being further coupled to wetting rollers.

8. An apparatus, according to claim 7, characterized in that each said cleaning unit is supplied by a single delivery device, supplying all the apparatus cleaning units, or by a delivery device for each said cleaning unit.

9. An apparatus, according to claim 1, characterized in that said cleaning material comprises CO₂ pellets at a high pressure and temperature from −300° C. to 0° C.

10. An apparatus, according to claim 1, characterized in that said cleaning material comprises CO₂ pellets at a high pressure and a temperature of about −80° C.
